(19) United States
(12) Patent Application Publication
(10) Pub. No.: US 2025/0371082 A1
(43) Pub. Date: Dec. 4, 2025

(54) SCRAPE TIME CALCULATOR

(71) Applicant: OXYLABS, UAB, Vilnius (LT)

(72) Inventors: Tadas GEDGAUDAS, Vilnius (LT); Tadas MALINAUSKAS, Vilnius (LT)

(73) Assignee: OXYLABS, UAB, Vilnius (LT)

(21) Appl. No.: 18/732,041

(22) Filed: Jun. 3, 2024

(51) Int. Cl. G06F 16/951

(52) U.S. Cl. CPC G06F 16/951; G06F 16/9537

(57) ABSTRACT

Disclosed herein are system, method, and computer program product embodiments for improving web scraping technology by dynamically updating scraping parameters. A scrape system may retrieve a webpage addressed at a target URL. The scrape system may compile an object list from the webpage. The scrape system may determine a number of objects in the object list. Based on the determined number of objects, the scrape system may determine a next time to retrieve the webpage addressed at the target URL such that, when the determined number of objects is greater, the next time is sooner. When the determined next time occurs, the scrape system may re-retrieve the webpage addressed at the target URL.

### BACKGROUND

### Field

This field is generally related to improving web scraping technology by dynamically updating scraping parameters.

### Related Art

Web scraping (also known as screen scraping, data mining, web harvesting) is the automated gathering of data from the Internet. It is the practice of gathering data from the Internet through any means other than a human using a web browser. Web scraping is usually accomplished by executing a program that queries a web server and requests data automatically, then parses the data to extract the requested information.

To conduct web scraping, a program known as a web crawler may be used. A web crawler, sometimes called a web spider, is a program or an automated script which performs the first task, i.e. it navigates the web in an automated manner to retrieve data, such as Hypertext Transfer Markup Language (HTML) data, JSONs, XML, and binary files, of the accessed websites.

Web scraping is useful for a variety of applications. In a first example, web scraping may be used for search engine optimization. Search engine optimization (SEO) is the process of improving the quality and quantity of website traffic to a website or a web page from search engines. A web search engine, such as the Google search engine available from Google Inc. of Mountain View, California, has a particular way of ranking its results, including those that are unpaid. To raise the location of a website in search results, SEO may, for example, involve cross-linking between pages, adjusting the content of the website to include a particular keyword phrase, or updating content of the website more frequently. An automated SEO process may need to scrape search results from a search engine to determine how a website is ranked among search results.

In a second example, web scraping may be used to identify possible copyright. In that example, the scraped web content may be compared to copyrighted material to automatically flag whether the web content may be infringing a copyright holder's rights. In one operation to detect copyright claims, a request may be made of a search engine, which has already gathered a great deal of content on the Internet. The scraped search results may then be compared to a copyrighted work.

In a third example, web scraping may be useful to check placement of paid advertisements on a webpage. For example, many search engines sell keywords, and when a search request includes the sold keyword, they place paid advertisements above unpaid search results on the returned page. Search engines may sell the same keyword to various companies, charging more for preferred placement. In addition, search engines may segment as sales by geographic area. Automated web scraping may be used to determine ad placement for a particular keyword or in a particular geographic area.

In a fourth example, web scraping may be useful to check prices or products listed on e-commerce websites. For example, a company may want to monitor a competitor's prices to guarantee that their prices remain competitive.

To conduct web scraping, the web request may be sent through a proxy server. The proxy server then makes the request on the web scraper's behalf, collects the response from the web server, and forwards the web page data so that the scraper can parse and interpret the page. When the proxy server forwards the requests, it generally does not alter the underlying content, but merely forwards it back to the web scraper. A proxy server changes the request's source IP address, so the web server is not provided with the geographical location of the scraper. Using the proxy server in this way can make the request appear more organic and thus ensure that the results from web scraping represent what would actually be presented were a human to make the request from that geographical location.

Proxy servers fall into various types depending on the IP address used to address a web server. A residential IP address is an address from the range specifically designated by the owning party, usually Internet service providers (ISPs), as assigned to private customers. Usually a residential proxy is an IP address linked to a physical device, for example, a mobile phone or desktop computer. However, businesswise, the blocks of residential IP addresses may be bought from the owning proxy service provider by another company directly, in bulk. Datacenter IPs are IPs owned by companies, not by individuals. The datacenter proxies are typically IP addresses that are not in a natural person's home.

Requests to the web page may be made at various frequencies. In some embodiments, frequencies may be varied so as to make the request appear organic (e.g., originating from a human user). In some embodiments, frequencies may be varied based on the content of a web page.

E-commerce and search engine sites may prefer not to service web scraping requests or may try to limit web scraping requests. To that end, these sites may try to determine which of the requests it receives are automated and which requests are in response to a human web browsing request. When a web server identifies a request that the server believes to be automated, the server may block all requests coming from that proxy or requests having certain parameters from that proxy.

To identify which requests are automated, a web server may try to determine whether web requests coming from a particular IP address or subnet satisfy a pattern over time. To avoid detection, proxies may be rotated so that no single IP address makes too many requests. However, the supply of proxy IP addresses is limited. The IP address space (especially in IP version 4) in general is constrained. This limited supply is exasperated because many of the available IP addresses are labeled as data center IPs, and many target websites likely to be scraped refuse to service web requests from those IP addresses. As a result of the limited supply, taking proxy IP addresses out of circulation too quickly raises the cost of web scraping and can delay its.

In addition to consumption of IP addresses, the system resources (such as network and processing power) may be consumed by making redundant or unnecessary web scraping addresses. Also, some websites have CAPTCHA tests that require additional resources.

Systems and methods are needed for more efficient web scraping.

### BRIEF SUMMARY

In an embodiment, a method provides an environment for dynamically calculating a scrape time. In the method, a webpage addressed at the target URL is retrieved. An object list from the webpage is compiled. A number of objects in the object list is determined. Based on the determined number of objects, a next time to retrieve the webpage addressed at the target URL is determined. The next time is determined such that, when the determined number of objects is greater, the next time is sooner. When the determined next time occurs, the webpage addressed at the target URL is re-retrieved.

System, device, and computer program product aspects are also disclosed.

Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### DESCRIPTION OF THE DRAWINGS

The accompanying drawings are incorporated herein and form a part of the specification.

FIG. 1 is a block diagram illustrating various functional components of a scraping environment, according to some embodiments.

FIG. 2 is a block diagram illustrating a scrape job pool, according to some embodiments.

FIG. 3 is a decision tree diagram illustrating a method for dynamically calculating a scrape time, according to some embodiments.

FIG. 4 is a flowchart illustrating a method for dynamically calculating a scrape time, according to some embodiments.

FIG. 5 is a block diagram illustrating a method for dynamically calculating a scrape time, according to some embodiments.

FIG. 6 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for dynamically calculating a scrape time.

Web scraping often involves optimizing: (1) making requests seem organic (e.g., from a human), so that the web server responds to the scrape request; and (2) retrieving the necessary content for the scraping task. For example, a web scraper may be used track financial markets, product pricing, social media activity, or any other internet activity. Entities relying on web scrapers may need accurate and current information. However, constantly scraping a web page may alert the server hosting the page, and risk the server blocking the requests.

Current systems may rely on static request frequencies used to determine when to scrape a target web server. For example, a current system may make a request to a target web page every minute, every 30 seconds, every 10 seconds, etc. This value may be manually set and manually updated. However, the target server may be configured to detect the patterns denoted by the request frequency, and deny the request. Current systems may further randomly change the frequency at which requests are made, without regard to the content scraped. This strategy is suboptimal because new content, at the target webpage may be missed. For example, if the time between web scrapes is too long, updates to the web page may be missed during the waiting period between scrapes.

To address such issues, embodiments herein describe a system to dynamically update scrape time frequency so as to make requests appear organic while maximizing the amount of content scraped from the target web page. The system updates the scrape time based on the amount of content retrieved from the web page. The more content returned from a web page, the more frequently scrape requests are sent. The less content returned from a web page, the less frequently scrape requests are sent. For example, a news site rapidly publishing new content regarding an unfolding story may be scraped more frequently than a blog updated once per week. This determination may be made based on the large amount of new content detected in each subsequent scrape of the news site, compared to the small amount of new content detected at the blog. This process is beneficial because: (1) by changing the time between scrapes, requests appear more organic and are less likely to be blocked; and (2) the scraping process will retrieve the most current information because the frequency is based on the amount of retrieved information. Using the news site example above, as the story unfolds and updates are made more rapidly, the system herein may detect the new content, and scrape the news site more rapidly. However, once the news site updates less frequently, the system may detect fewer changes to the content, and reduce the frequency of web scrapes. As stated above this will increase server responses to the scrapes because the varied frequency makes them appear organic while maximizing the amount of content retrieved per scrape.

Various embodiments of these features will now be discussed with respect to the corresponding figures.

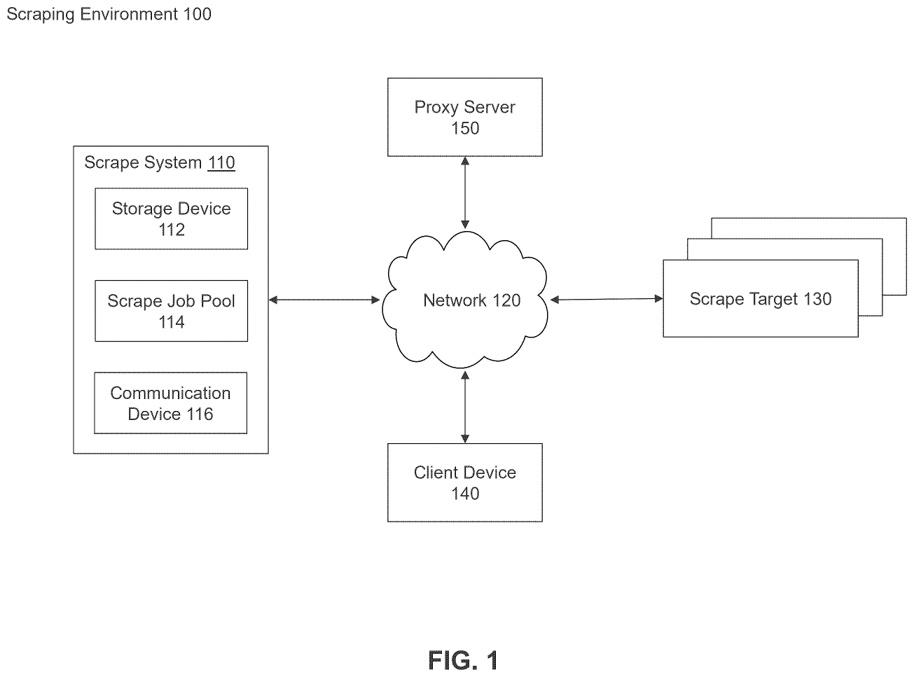

FIG. 1 depicts a block diagram illustrating various functional components of a scraping environment 100, according to some embodiments. Scraping environment 100 includes scrape system 110, network 120, scrape target 130, client device 140, and proxy server 150.

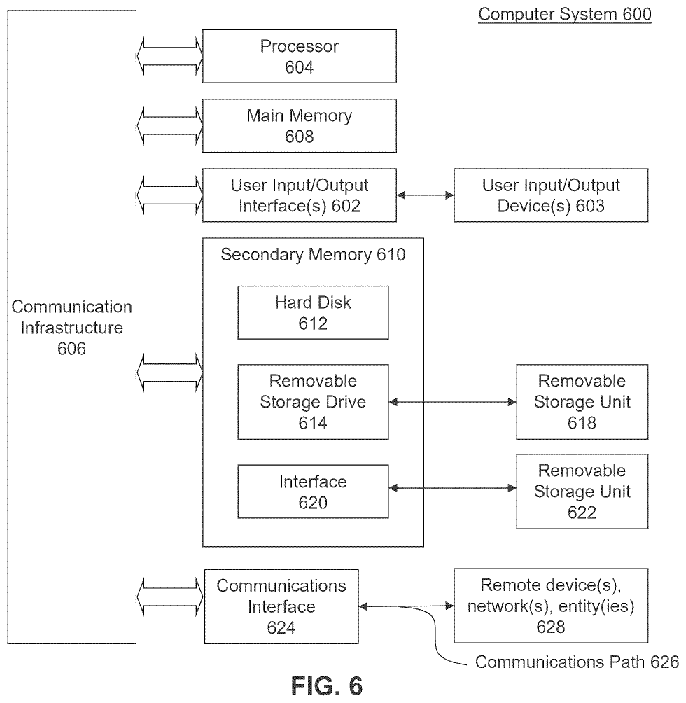

Scrape system 110 may be implemented using one or more servers and/or databases. For example, scrape system 110 may include one or more proxy servers. In some embodiments, scrape system 110 may be implemented using a computing device such as a desktop workstation, laptop or notebook computer, netbook, tablet, smart phone, and/or other computing device. In some embodiments, scrape system 110 may be implemented as an application in an enterprise computing system and/or a cloud- computing system. In some embodiments, scrape system 110 may be a computer system such as computer system 600 described with reference to FIG. 6.

Scrape system 110 may be configured to receive and execute web scrape requests. Web scrape requests may be received from any entity connected to scrape system 110, such as client device 140. For example, scrape system 110 may formulate a series of HTTP requests to the target website (e.g., scrape target 130) to retrieve results as specified in the request, such as a desired content within an HTML page. Scrape system 110 includes storage device 112, scrape job pool 114, and communication device 116.

Communications device 116 may be configured to communicate with scrape target 130 and client device 140. Communications device 116 may be configured to communicate via network 120. Communications device 116 may comprise any suitable network interface capable of transmitting and receiving data, such as, for example a modem, an Ethernet card, a communications port, or the like. Communications device 116 may be able to transmit data using any wireless transmission standard such as, for example, Wi-Fi, Bluetooth, cellular, or any other suitable wireless transmission.

Storage device 112 may be any memory device. Storage device 112 may be used to store scraped data from scrape target 130. For example, client device 140 may send a request to scrape system 110 to scrape data from an e-commerce website (e.g., scrape target 130) to check the prices of certain products. Scrape system 110 may perform the scraping operation and save the product prices at storage device 112.

Scrape job pool 114 may be a data structure to organize scrape requests at scrape system 110. Although a single scrape job pool 114 is depicted, scrape system 110 may include multiple scrape job pools 114. Scrape system 110 may be configured to run multiple execution threads. The execution threads may be assigned to the scrape job pools 114 so that multiple scrape jobs may be executed by scrape system 110 in parallel. For example, each scrape job may have its own execution thread. Scrape system 110 may receive scrape requests from one or more client devices 140. A single client device 140 may submit multiple scrape requests. For example, client device 140 may submit three scrape requests for three scrape targets 130. Scrape system 110 may store the scrape request information at scrape job pool 114. Each request may have its own thread.

In some embodiments, a scrape request may be a request to retrieve content only once. For example, the request may be to retrieve price information from a competitor's website a single time. In some embodiments, a scrape request may include a flag indicating that the request should repeat. For example, the request may be to repeatedly retrieve price information from a competitor's website. In some embodiments, the request may include a frequency to re-retrieve content from the webpage. The frequency may be any time period such as 10 seconds, 1 minute, or 5 minutes. The frequency may be used to set a timer that causes scrape system 110 to re-execute the scrape process. In some embodiments, scrape system 110 may use a default frequency value (e.g., 10 seconds, 1 minute, and 5 minutes). Scrape system 110 may use a default frequency value if client device 140 does not indicate a frequency value in the scrape request. Once the timer associated with a scrape request ends, scrape system 110 may retrieve the scrape request from scrape job pool 114 and execute it (e.g., scrape the webpage at the target URL). In some embodiments, scrape system 110 may set a default frequency if no results are returned. For example, scrape system 110 may set use a default frequency of 60 minutes of no results are returned from the webpage at the target URL.

Scrape target 130 may be computer software and underlying hardware that accepts requests and returns responses via HTTP. Scraping environment may include any number of scrape targets 130. As input, scrape target 130 may typically takes the path in the HTTP request, any headers in the HTTP request, and sometimes a body of the HTTP request, and uses that information to generate content to be returned. The content served by the HTTP protocol is often formatted as a webpage, such as using HTML and JavaScript. For example, scrape system 110 may send one or more HTTP requests to scrape target 130. Scrape target 130 may return content to scrape system 110 according to the HTTP request(s).

Client device 140 may be any entity attempting to leverage scrape system 110. Client device 140 may be a computer system such as computer system 600 described with reference to FIG. 6. Client device 140 may be a client system such as a desktop workstation, laptop or notebook computer, netbook, tablet, smart phone, and/or other computing device that may be using an enterprise computing system.

Client device 140 may interact with scrape system 110 in various ways. In an embodiment, client device 140 may send scrape request to scrape system 110 with the parameters describing the web scraping sought to be completed. The request and its parameters may conform to an API set forth by scrape system 110. The parameters may include a Uniform Resource Locator (URL), Uniform Resource Identifier (URI), header information, geolocation information, and browser information. In some embodiments, the parameters may be associated with the webpage at the scrape target (e.g., scrape target 140). For example, if the webpage is an e-commerce cite, parameters may include a product and associated price range. As another example, if the webpage is a job search website, parameters may include a role, geolocation, and radius. Parameters may further include a repeat flag, indicating whether the request should be repeated. If the repeat flag is set to true, parameters may further include an optional frequency value. As discussed above, the frequency value may be used as a timer to determine how often the scrape request is repeated. In some embodiments, scrape system 110 may utilize a default frequency value. For example, if client device 140 fails to include a frequency value, scrape system 110 may use a default value.

In response to the request, scrape system 110 may return an acknowledgment that the request is received. The acknowledgment may include a message indicating that the scraped results will be available at a particular location. Scrape system 110 may queue the request and, when the scraped results are retrieved, a message, also called a callback, may be sent to client device 140 indicating that scraped results are available. For example, scrape system 110 may formulate and client device 140 a notification, email, SMS, phone call, or any other alert, indicating the results are available. In some embodiments, scrape system 110 may send results directly to client device 140. For example, scrape system 110 may transmit a zip file including scraped results to client device 140. In this way, scrape system 110 can asynchronously service a client request for the scrape data. Scraped results may be stored at storage device 112.

Alternatively or additionally, client device 140 may send the request, as described above, an in addition to an acknowledgment, scrape system 110 may keep the connection with client device 140 open while the scraping is being conducted. Once the scraping is completed, the results are returned in a response to the initial request. For example, scrape system 110 may send, in real-time (e.g., a stream) results to client device 140. In this way, scrape system 110 can synchronously service a client request for the scrape data. In some embodiments, scrape system 110 may also copy and save the live real-time results to storage device 112. As will be discussed below, this may be beneficial for updating scrape frequencies.

In some embodiments, scrape system 110 may not send the requests directly to scrape target 130 and instead send them through at least one intermediary proxy server. For example, scrape system 110 may send requests through proxy server 150. Although a single proxy server 150 is depicted, scraping environment 100 may include multiple proxy servers 150. Proxy server 150 may be implemented using one or more servers and/or databases. For example, proxy server 150 may include one or more proxy servers. In some embodiments, proxy server 150 may be implemented using a computing device such as a desktop workstation, laptop or notebook computer, netbook, tablet, smart phone, and/or other computing device. In some embodiments, proxy server 150 may be implemented as an application in an enterprise computing system and/or a cloud-computing system. In some embodiments, proxy server 150 may be a computer system such as computer system 600 described with reference to FIG. 6.

To send the request to proxy server 150, a proxy protocol may be used. To send a request according to an HTTP proxy protocol, the full URL may be passed, instead of just the path. Also, credentials may be required to access the proxy. All the other fields for an HTTP request must also be determined. To reproduce an HTTP request, scrape system 110 may generate all the different components of each request, including a method, path, a version of the protocol that the request wants to access, headers, and the body of the request. There may be several proxy servers 150 used to perform a request from client device 140. For example, the request may include two proxy servers 150. The first proxy server 150 may receive the request from client device 140 and forward it to a second proxy server 150. The second proxy server 150 may forward the request to scrape target 130, receive the results, and forward the results to the first proxy server 150. Subsequently, the first proxy server 150 may send the results to client device 140.

Each scrape may represent a sequence of request-and-response interactions with scrape target 130. This, for example, may serve to retrieve or establish session information for scrape target 130 to return the desired results (e.g., webpage retrieval). For example, a website (e.g., scrape target 130) may use cookies to track interactions (e.g. sessions) with client device 140.

An HTTP cookie (usually just called a cookie) is a simple computer data structure made of text written by a web server in previous request-response cycles. The information stored by cookies can be used to personalize the experience when using a website. A website can use cookies to find out if someone has visited a website before and record data about what they did. When someone is using a computer to browse a website, a personalized cookie data structure can be sent from the website's server to the person's computer. The cookie is stored in the web browser on the person's computer. At some time in the future, the person may browse that website again. When the website is found, the person's browser checks whether a cookie for that website is found and available. If a cookie is found, then the data that was stored in the cookie before can be used by the website to tell the website about the person's previous activity. Some examples where cookies are used include shopping carts, automatic login, and remembering which advertisements have already been shown.

Because many websites require session information, usually stored in cookies but possibly received in other data from previously visited retrieved pages, scrape system 110 may reproduce a series of HTTP requests and responses to scrape data from scrape target 130. For example, to scrape search results, embodiments described herein may first request the page of the general search page where a human user would enter her search terms in a text box on an HTML page. If it were a human user, when the user navigates to that page, the resulting page would likely write a cookie to the user's browser and would present an HTML page with the text box for the user to enter her search terms. Then, the user would enter the search terms in the text box and press a “submit” button on the HTML page presented in a web browser. As a result, the web browser would execute an HTTP POST or GET operation that results in a second HTTP request with the search term and any resulting cookies. According to an embodiment, scrape system 110 may reproduce both HTTP requests, using data, such as cookies, other headers, parameters or data from the body, received in response to the first request to generate the second request.

Scrape system 110 may perform a first scrape of the target webpage and store the results. Subsequently, scrape system 110 may update the frequency of a scrape request based on results from the scrape. Scrape system 110 may compare results of the most recent scrape to prior results to determine whether to update the frequency. If new content is identified in the current scrape, scrape system 110 may increase the scrape frequency so content is retrieved sooner. As will be discussed below, the more new content that is identified, the sooner the next scrape may occur. If no new content is identified, scrape system 110 may not update the scrape frequency.

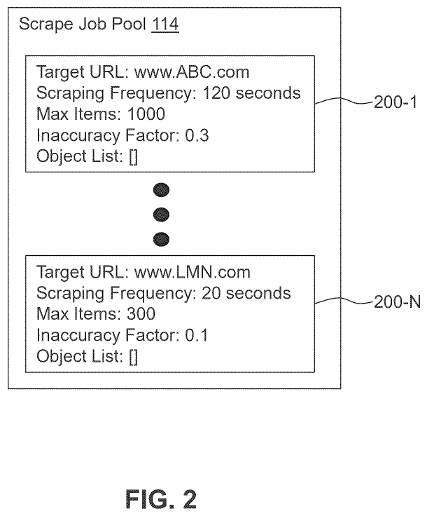

FIG. 2 is a block diagram illustrating a scrape job pool 114, according to some embodiments. As discussed above, scrape job pool 114 may be a data structure to store one or more scrape requests 200 at scrape system 110. Scrape request 200 may be created by scrape system 110 in response to a request by client device 140. Scrape job pool 114 may include any number of scrape requests 200. Additionally, scrape system 110 may include any number of scrape job pools 114. This may be beneficial to execute multiple scrape requests in parallel.

Scrape request 200 may include various parameters such as a target URL, scraping frequency, max items, an inaccuracy factor, and an object list. Target URL may be a URL to scrape. Target URL may be a URL of scrape target 130 on network 120. Scraping frequency may be a value used to determine when scrape request 200 is repeated. Scraping frequency may be updated by scrape system 110 based on results of the scrape. Max items may be used to determine how much data to retrieve from the webpage at the target URL. For example, if the scrape request is to perform a search at the target URL webpage, max items may be the default number of items returned via a search at the webpage. In some embodiments, scrape system 110 may use a default value for max items if client device 140 doesn't provide one. An inaccuracy factor may be used by scrape system 100 when recalculating the scrape frequency. As discussed above, scrape system 110 may be optimized to retrieve the most up to date content while making requests appear organic. However, web sites (e.g., scrape target 130) may be updated sporadically. For example, an e-commerce site may update prices on their site once per week throughout the year, but update prices once per day during a holiday or sale period. To account for changes in the behavior of scrape target 130, inaccuracy factor may be used to scale the update scrape frequency so that new content is not missed as the webpage at scrape target 130 is updated. The larger the inaccuracy factor, the more frequently the scrape request may be repeated. The inaccuracy factor may be a percentage, multiplied by the scrape frequency. For example, if a scrape frequency is 60 seconds, and an inaccuracy factor is 50%, then including the inaccuracy factor would result in a new scrape frequency of 30 seconds (60*0.5). In some embodiments, client device 140 may provide an inaccuracy factor. In some embodiments, scrape system 110 may use a default inaccuracy factor.

Scrape request 200 may further include an object list. Although a single, object list is depicted, scrape request 200 may include multiple object lists. An object list may be a data structure used to store a sequence of similarly typed or formatted data items retrieved from the target URL. For example, the object list may include raw HTML from the webpage at the target URL, links (e.g., URLs) accessible via the webpage at the target URL, parsed data from the raw HTML at the webpage, or a combination thereof.

When scrape request 200 is first created in response to a request by client device 140, the object list may be empty. Once scrape system 110 scrapes the target URL, scrape system 110 may populate the object list with data from the webpage at the target URL. For example, scrape request 200 may be for a job posting website, specifically for software engineering jobs in New York City. Scrape system 110 may scrape the job posting site (e.g., scrape target 130) and populate the object list with returned content. For example, scrape system 110 may add the URL of each software engineer job posting within the object list. As an additional example, scrape request 200 may be a product search at an e- commerce website. The search may be for headphones. Here, scrape system 110 may scrape the e-commerce website by performing a search, and populate object list with the search results. Scrape system 110 may add the URL of each item returned by the search for headphones. In some embodiments, scrape system 110 may search the HTML at the webpage to populate the list. For example, scrape system 110 may search the HTML for values such as “product” and “price” to populate the object list with product and price key value pairs. The key may be the product (e.g., the headphone) and the value may be the product's cost as listed in the webpage's HTML.

Scrape system 110 may save the object list in order to determine whether to update the scrape frequency (e.g., time between scrapes). Scrape system 110 may receive a scrape request, perform a first scrape and save data from the scrape in the object list. Scrape system 110 may wait for the scrape frequency time before performing the second scrape of the target URL. Scrape system 110 may determine the frequency time has occurred, and perform the second scrape. Scrape system 110 may compare data from the second scrape to data from the first scrape stored in the object list. If data from the second scrape includes new or updated data, scrape system 110 may update the scrape frequency such that the third scrape occurs sooner. Scrape system 110 may save data from the second scrape at the object list. In some embodiments, scrape system 110 may only save data from the most recent scrape. For example, scrape system 110 may overwrite the object list on each scrape. In some embodiments, scrape system 110 may be configured to save data from the last N number of scrapes. For example, scrape system 110 may create three object lists to save data from the most recent three scrapes of the target URL. Scrape system 110 may use a default number of object lists (e.g., one) for each scrape request. Client device 140 may specify a number of object lists within its scrape request.

Scrape system 110 may filter the object list by removing objects present in a prior object list. For example, if a job posting at a career website has already been scraped and stored at a prior object list, scrape system 110 may remove the job posting from the object list corresponding to the current scrape. Scrape system 110 may further filter the object list by removing duplicate items within the object list. For example, a webpage at the target URL may include duplicate links. Here, scrape system 110 may remove one of the links from the object list to prevent duplicate data from being saved.

Scrape system 110 may sort scrape requests 200 within scrape job pool 114. For example, scrape job pool 114 may be sorted by scrape time frequency such that the first scrape request 200 in scrape job pool 114 is the next scrape job to occur based on remaining frequency time.

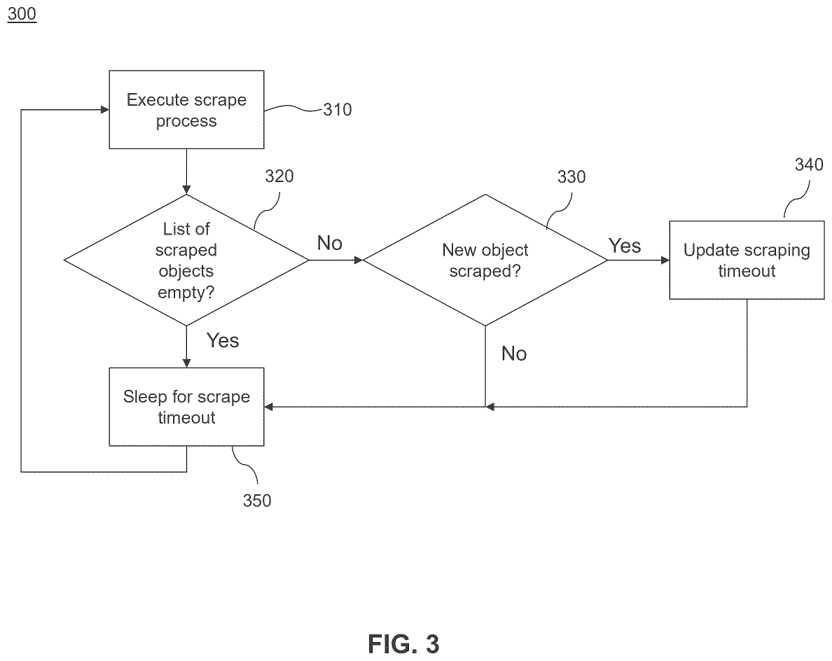

FIG. 3 depicts a flowchart decision tree diagram illustrating a method 300 for dynamically calculating a scrape time, according to some embodiments. Method 300 shall be described with reference to FIG. 1, however, method 300 is not limited to that example embodiment.

In an embodiment, scrape system 110 may utilize method 300 to update a scraping frequency. If the scrape requests includes new data, the scrape frequency for the scrape process may be updated. The foregoing description will describe an embodiment of the execution of method 300 with respect to scrape system 110. While method 300 is described with reference to scrape system 110, method 300 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3.

At 310, scrape system 110 executes a scrape process. As discussed above, a scrape process may be a request from a device such as client device 140 to retrieve content from a webpage (e.g., scrape target 130). The request may include a scrape frequency to determine how often scrape system 110 should re-retrieve data from the webpage at the target URL. In some embodiments, scrape system 110 may use a default time to wait before retrieving the webpage at the target URL.

In some embodiments, scrape system 110 may utilize one or more proxy servers (e.g., proxy server 150) during the scrape process. Scrape system 110 may execute the scrape process and retrieve content from scrape target 130. Scrape system 110 may be configured to search HTML at the target URL webpage for specific content. Scrape system 110 may be further configured to execute a search via search feature at the target URL webpage for specific content. For example, client device 140 may submit a scrape request to scrape system 110 to search a job posting website for sales jobs in the Washington, D.C. area. The website may include a search feature used to search for job postings. Here, scrape system 110 may formulate an HTTP request including a path to access and execute the search feature at the target website. For example, scrape system 110 may configure the HTTP request to use the target website search feature to search for Washington, D.C. sales jobs. The website may return content within an HTTP response to scrape system 110. For example, the response may include available sales jobs near Washington, D.C. Scrape system 110 may store the content at storage device 112. Scrape system 110 may compile a list of objects returned from the target website. The object list may include data from the target website such as a URL accessible via the webpage at the target URL, raw HTML from the webpage at the target URL, data parsed from the webpage's raw HTML, or a combination thereof. Here, the object list may include one or more URLs. Each URL may be a link to a sales job identified by the search at the jobs website.

At 320, scrape system 110 determines whether an object list returned by the scrape process is empty. The object list may be empty if the requested content does not exist at the webpage. For example, using the sales job example above, the search may not return any results because no jobs are available given the search parameters. The object list may be empty if the URL path specified does not exist. If the object list is empty, method 300 proceeds to 350. If the object list is not empty, method 300 proceeds to 330. The object list may be the content scraped from scrape target 130. In some embodiments, the object list may include links (e.g., URLs) to content on the scraped web page. In some embodiments, the object list may include parsed HTML content such as product information on an e-commerce website. In some embodiments, object list may include raw HTML from scrape target 130.

At 330, scrape system 110 determines whether a new object has been scraped from the scrape target. If a new object has been scraped, method 300 proceeds to 340. If none of the objects are new (e.g., the object list is equal to a prior object list), or scrape target 130 has not been previously scraped, method 300 proceeds to 350. To make the determination, scrape system 110 may compare the object list of the current scrape (e.g., at 310) to a prior object list compiled via a previous scrape of the target (e.g., scrape target 130). The prior object list may be stored within scrape request 200 at scrape job pool 114.

A new object may be data from scrape target 130 not previously scraped, or data that has changed. For example, scrape target 130 may be an e-commerce site, and during a first scrape, a first product may have been identified. Subsequently, on a second scrape, a second product may be identified. Since the second product was not identified in the first scrape, method 300 proceeds to 340. In some embodiments, changes to data previously scraped may cause method 300 to proceed to 340. For example, if the value (e.g., price) of data on scrape target 130 changes, method 300 proceeds to 340.

At 340, scrape system 110 updates the scrape frequency. Scrape system 110 may use the number of objects in the object list to update the scrape frequency. In some embodiments, scrape system 110 may use the total number of objects in the object list to update the frequency. In some embodiments, scrape system 110 may use the number of new or updated objects in the object list to update the frequency. Scrape system may determine a next time to retrieve the webpage (e.g., scrape frequency) addressed at the target URL such that, when the determined number of objects is greater, the next time is sooner. Stated alternatively, the more data scraped from scrape target 130, the more frequently scrape system 110 will repeat the scrape process.

In some embodiments, scrape system 110 may update the frequency dividing a scrape frequency parameter by the number of objects in the object list to determine an update frequency. Scrape system 110 may then multiply the update frequency by a maximum number parameter specifying a maximum number of objects expected to be found on the webpage, to determine the next time. Scrape system may then multiply the next time by an inaccuracy factor to account for behavior by scrape target 130.

At 350, the scrape process sleeps for the scrape timeout period. The scrape timeout period may be the time between scrapes defined by the scrape frequency (e.g., one minute). Scrape system 110 may place the scrape process within scrape job pool 114. Scrape system 110 may remove the scrape process from scrape job pool 114 once the timeout period passes. Once removed, scrape system 110 repeat method 300 by executing the scrape process at 310.

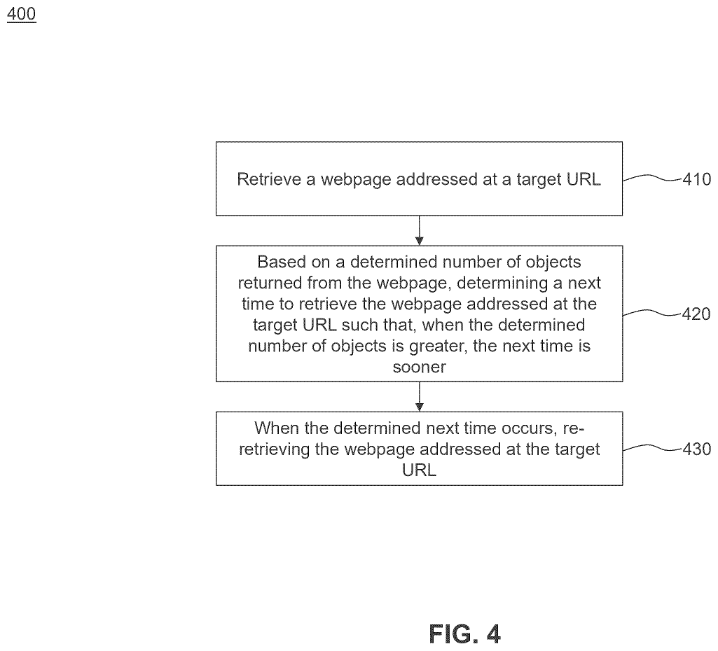

FIG. 4 depicts a flowchart illustrating a method 400 for dynamically calculating a scrape time, according to some embodiments. Method 400 shall be described with reference to FIG. 1, however, method 400 is not limited to that example embodiment.

In an embodiment, scrape system 110 may use method 400 to scrape a webpage according to a scrape frequency. Scrape system 110 may further use method 400 to update the scrape frequency. The foregoing description will describe an embodiment of the execution of method 400 with respect to scrape system 110. While method 400 is described with reference to scrape system 110, method 400 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4.

At 410, scrape system 110 retrieves a webpage at a target URL. The webpage may be hosted by scrape target 130. As discussed above, scrape system 110 may retrieve the webpage through one or more HTTP requests. Scrape system 110 may use proxy server 150 to access the webpage and retrieve content. In some embodiments, scrape system 110 may save data (e.g., content) from the webpage at storage device 112. For example, scrape system 110 may save raw HTML from the webpage. In some embodiments, scrape system 110 may parse the webpage HTML and save the parsed data. Scrape system 110 may compile an object list using the data from the target webpage. For example, the object list may include links (e.g., URLs) to other content at the webpage, raw HTML data, parsed HTML data, or a combination thereof. Scrape system may determine a number of objects in the object list.

At 420, scrape system 110 may determine a next time to retrieve the webpage addressed at the target URL based on a determined number of objects returned from the webpage. The next time to retrieve the webpage may be determined, such that, when the determined number of objects is greater, the next time is sooner. In some embodiments, scrape system 110 may make a comparison between the number of objects retrieved during the current scrape (e.g., at 410) and a previous scrape of the target URL. In some embodiments, the comparison may only consider new or updated data at the target URL. For example, the webpage at the target URL may not have changed between a previous and current scrape. Therefore, the time to scrape the target URL next (e.g., scrape frequency) may not be updated. In contrast, if new data is detected at the webpage, the next scrape time may be sooner in order to capture new data as it is added to the webpage. Scrape system 110 may save the next time (e.g., scrape frequency) at a data structure defining the scrape job, stored within scrape job pool 114. The data structure may include the target URL, scrape frequency (e.g., next time to scrape), maximum number of items to retrieve, and an inaccuracy factor.

At 430, when the determined next time occurs, scrape system 110 re-retrieves the webpage addressed at the target URL. Scrape system 110 may re-retrieve the webpage based on a timer at the scrape job data structure ending. The timer may be set to the next time (e.g., scrape frequency) determined at 420.

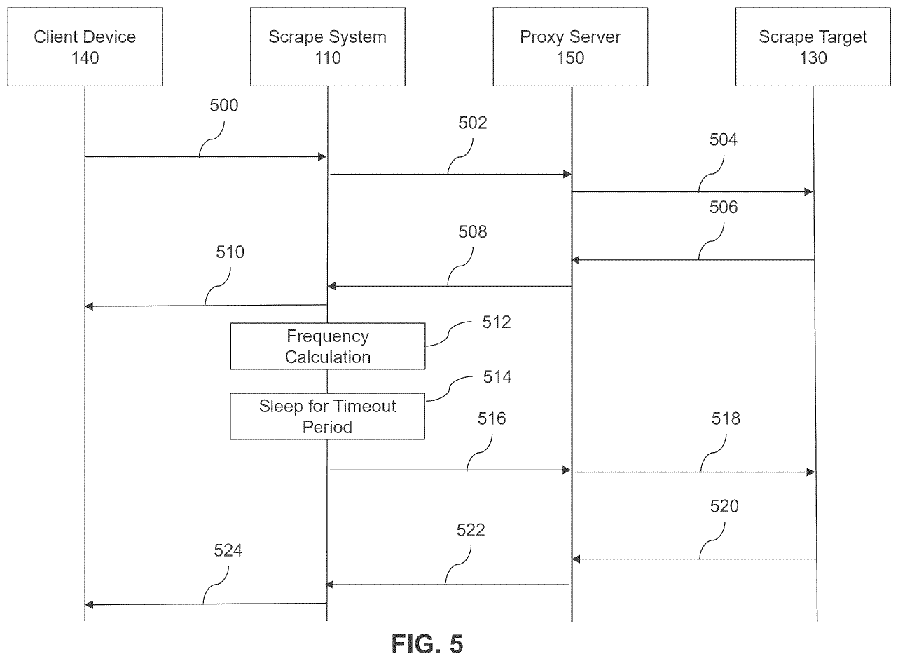

FIG. 5 is a block diagram illustrating a method for dynamically calculating a scrape time, according to some embodiments. At 500, client device 140 may send a scrape request to scrape system 110. The request may include a Uniform Resource Locator (URL), Uniform Resource Identifier (URI), header information, geolocation information, and browser information. In some embodiments, the parameters may be associated with the webpage at the scrape target (e.g., scrape target 140). For example, if the webpage is an e-commerce cite, parameters may include a product and associated price range. As another example, if the webpage is a job search website, parameters may include a role, geolocation, and radius. The request may include a flag indicating whether scrape system 110 should repeat the scrape request. If the flag is set to true, the request may further include an initial repeat frequency. If a frequency is not included, scrape system 110 may use an initial default frequency (e.g., 30 seconds, 60 seconds).

At 502, scrape system performs the scrape request. In some embodiments, scrape system may send the scrape request to one or more proxy servers 150. At 504, proxy server 150 may scrape the requested content from scrape target 130. At 506, scrape target 130 may return the requested content to proxy server 150. At 508, proxy server 150 may forward the content to scrape system 110. At 510, scrape system 110 may send the returned content to client device 140.

At 512, scrape system 110 may update the scrape frequency. As discussed above, scrape system 110 may utilize the number of unique objects returned from scrape target 130 to update the scrape frequency. Scrape system 110 may determine whether unique objects were scraped by comparing results of the current scrape to results from one or more previous scrape operations at scrape target 130. For example, the more unique content retrieved from scrape target 130, the more frequently scrape system 110 will scrape content from scrape target 130. Similarly, if no new content was retrieved from scrape target 130, scrape system 110 may use the same timeout period, or increase the time between scrapes. At 514, scrape system 110 sleeps for the recalculated timeout period. In some embodiments, scrape system 110 may place the scrape job within a scrape job pool, such as scrape job pool 114.

At 516, scrape system 110 determines the timeout period has finished and repeats the scrape request. Scrape system 110 may forward the request to proxy server 150. At 518, proxy server 150 may scrape the requested content from scrape target 130. At 520, scrape target 130 may return the requested content to proxy server 150, and at 522 proxy server 150 may forward the content to scrape system 110. At 524, scrape system 110 may forward the content to client device 140.

Although requests from scrape system 110 to scrape target 130 are depicted using proxy server 150, in some embodiments, scrape system 110 may directly scrape content from scrape target 130. For example, scrape system 110 may directly send one or more HTTP requests to scrape target 130.

The disclosure presents a computer-implemented method for scraping content from a target URL, comprising:
(a) retrieving a webpage addressed at the target URL;
(b) compiling an object list from the webpage;
(c) determining a number of objects in the object list;
(d) based on the determined number of objects, determining a next time to retrieve the webpage addressed at the target URL such that, when the determined number of objects is greater, the next time is sooner; and
(e) when the determined next time occurs, re-retrieving the webpage addressed at the target URL.

The method is presented, wherein the determining the next time comprises:
(a) dividing a scrape frequency parameter by the number of objects in the object list to determine an update frequency, the scrape frequency parameter specifying a time to wait before retrieving the webpage at the target URL; and
(b) multiplying the update frequency by a maximum number parameter specifying a maximum number of objects expected to be found on the webpage

The method is presented, wherein retrieving the webpage addressed at the target URL (a) comprises searching HTML at the target URL webpage for a specific content.

The method is presented, wherein retrieving the webpage addressed at the target URL (a) comprises executing a search via a search feature at the target URL webpage for a specific content.

The method is presented, wherein the object list comprises an object, wherein the object is a URL accessible via the webpage at the target URL

The method is presented, further comprising:
(f) determining at least one of: (1) that the object list is empty or (2) that the object list is equal to a prior object list retrieved from the target web page; and
(g) setting the next time to a default time, the default time specifying a time to wait before retrieving the webpage at the target URL.

The method is presented, wherein determining a number of objects in the object list further comprises removing an object from the object list, wherein the object is in a prior object list returned from the target web page by a prior retrieval of the webpage.

The method is presented, wherein the next time to retrieve the webpage at the target URL is determined based on a determined number of non-overlapping objects in the object list compared to a previously retrieved object list, such that when the determined number of non-overlapping objects is greater, the next time is sooner.

The method is presented, wherein the webpage retrieval comprises a plurality of request-response interactions to establish session information for the webpage retrieval.

A system is presented for scraping content from a target URL, comprising:
at least one processor;
a memory configured to:
(a) retrieve a webpage addressed at the target URL;
(b) compile an object list from the webpage;
(c) determining a number of objects in the object list;
(d) based on the determined number of objects, determine a next time to retrieve the webpage addressed at the target URL such that, when the determined number of objects is greater, the next time is sooner; and
(e) when the determined next time occurs, re-retrieve the webpage addressed at the target URL.

The system is presented, wherein to determine the next time, the at least one processor is further configured to:
(a) divide a scrape frequency parameter by the number of objects in the object list to determine an update frequency, the scrape frequency parameter specifying a time to wait before retrieving the webpage at the target URL; and
(b) multiply the update frequency by a maximum number parameter specifying a maximum number of objects expected to be found on the webpage, to determine the next time.

The system is presented, wherein to retrieve the webpage addressed at the target URL, the at least one processor is further configured to search HTML at the target URL webpage for a specific content

The system is presented, wherein to retrieve the webpage at the target URL, the at least one processor is further configured to execute a search via a search feature at the target URL webpage for a specific content.

The system is presented, wherein the object list comprises an object, wherein the object is a URL accessible via the webpage at the target URL

The system is presented, wherein the at least one processor is further configured to:
(f) determine at least one of: (1) that the object list is empty or (2) that the object list is equal to a prior object list retrieved from the target web page; and
(g) set the next time to a default time, the default time specifying a time to wait before retrieving the webpage at the target URL.

The system is presented, wherein to determine a number of objects in the object list, the at least one processor is further configured to remove an object from the object list, wherein the object is in a prior object list returned from the target web page by a prior retrieval of the webpage.

The system is presented, wherein the at least one processor is configured to determine the next time to retrieve the webpage at the target URL based on a determined number of non-overlapping objects in the object list compared to a previously retrieved object list, such that when the determined number of non-overlapping objects is greater, the next time is sooner

The system is presented, wherein the webpage retrieval comprises a plurality of request-response interactions to establish session information for the webpage retrieval.

The disclosure presents a non-transitory computer-readable device having instructions stored thereon is presented that, when executed by at least one computing device, cause the at least one computing device to perform operations, comprising:
(a) retrieving a webpage addressed at the target URL;
(b) compiling an object list from the webpage;
(d) determining a number of objects in the object list;
(d) based on the determined number of objects, determining a next time to retrieve the webpage addressed at the target URL such that, when the determined number of objects is greater, the next time is sooner; and
(e) when the determined next time occurs, re-retrieving the webpage addressed at the target URL.

The device is presented, wherein to determine the next time, the operations further comprising:
(a) dividing a scrape frequency parameter by the number of objects in the object list to determine an update frequency, the scrape frequency parameter specifying a time to wait before retrieving the webpage at the target URL; and
(b) multiplying the update frequency by a maximum number parameter specifying a maximum number of objects expected to be found on the webpage

The device is presented, wherein to retrieve the webpage addressed at the target URL (a) the operations further comprise searching HTML at the target URL webpage for a specific content.

The device is presented, wherein to retrieve the webpage addressed at the target URL (a) the operations further comprise executing a search via a search feature at the target URL webpage for a specific content.

The device is presented, wherein the object list comprises an object, wherein the object is a URL accessible via the webpage at the target URL.

The device is presented, the operations further comprising:
(f) determining at least one of: (1) that the object list is empty or (2) that the object list is equal to a prior object list retrieved from the target web page; and
(g) setting the next time to a default time, the default time specifying a time to wait before retrieving the webpage at the target URL.

The device is presented, wherein to determine a number of objects in the object list the operations further comprise removing an object from the object list, wherein the object is in a prior object list returned from the target web page by a prior retrieval of the webpage.

The device is presented, wherein the next time to retrieve the webpage at the target URL is determined based on a determined number of non-overlapping objects in the object list compared to a previously retrieved object list, such that when the determined number of non-overlapping objects is greater, the next time is sooner.

The device is presented, wherein the webpage retrieval comprises a plurality of request-response interactions to establish session information for the webpage retrieval.

Various embodiments may be implemented, for example, using one or more well- known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above- described exemplary embodiments, but should be defined only in accordance with the following claims and their equivalents.

1. A computer implemented method for scraping content from a target URL, comprising:
retrieving, by a computing device and via a network, a webpage addressed at the target URL at a first time;
compiling, by the computing device, an object list from the webpage;
determining, by the computing device, a number of objects in the object list;
retrieving, by the computing device and via the network, the webpage addressed at the target URL at a second time;
compiling, by the computing device, a second object list from the webpage;
determining, by the computing device, that a number of objects in the second object list is greater than the number of objects in the object list;
based on determining that the number of objects in the second object list is greater than the number of objects in the object list, determining, by the computing device, a third time to retrieve the webpage addressed at the target URL such that a difference between the second time and the third time is less than a difference between the first time and the second time, and
when the determined third time occurs, retrieving, by the computing device and via the network, the webpage addressed at the target URL.

2. The computer implemented method of claim 1, wherein determining the third time comprises:
dividing a scrape frequency parameter by the number of objects in the object list to determine an update frequency, the scrape frequency parameter specifying a time to wait before retrieving the webpage at the target URL; and
multiplying the update frequency by a maximum number parameter specifying a maximum number of objects expected to be found on the webpage, to determine the third time.

3. The computer implemented method of claim 1, wherein retrieving the webpage addressed at the target URL comprises searching HTML at the target URL webpage for a specific content.

4. The computer implemented method of claim 1, wherein retrieving the webpage addressed at the target URL comprises executing a search via a search feature at the target URL webpage for a specific content.

5. The computer implemented method of claim 1, wherein the object list comprises an object, wherein the object is a URL accessible via the webpage at the target URL.

6. The computer implemented method of claim 1, further comprising:
determining at least one of: (1) that the object list is empty or (2) that the object list is equal to the second object list; and
setting the third time to a default time.

7. The computer implemented method of claim 1, wherein determining a number of objects in the object list from the webpage further comprises removing an object from the object list, wherein the object is in a prior object list returned from the target web page by a prior retrieval of the webpage.

8. The computer implemented method of claim 1, wherein the third time to retrieve the webpage at the target URL is further determined based on a determined number of non-overlapping objects in the object list compared to the second object list.

9. The computer implemented method of claim 1, wherein the webpage retrieval comprises a plurality of request-response interactions to establish session information for the webpage retrieval.

10. A system for scraping content from a target URL, the system comprising:
a memory; and
at least one processor coupled to the memory and configured to:
retrieve, via a network, a webpage addressed at the target URL at a first time;
compile an object list from the webpage;
determine a number of objects in the object list;
retrieve, via the network, the webpage addressed at the target URL at a second time;
compile a second object list from the webpage;
determine a number of objects in the second object list is greater than the number of objects in the object list;
based on determining the number of objects in the second object list is greater than the number of objects in the object list, determine a third time to retrieve the webpage addressed at the target URL such that a difference between the second time and the third time is less than a difference between the first time and the second time;
when the determined third time occurs, retrieve, via the network, the webpage addressed at the target URL.

11. The system of claim 9, wherein to determine the third time, the at least one processor is further configured to:
divide a scrape frequency parameter by the number of objects in the object list to determine an update frequency, the scrape frequency parameter specifying a time to wait before retrieving the webpage at the target URL; and
multiply the update frequency by a maximum number parameter specifying a maximum number of objects expected to be found on the webpage, to determine the third time.

12. The system of claim 9, wherein to retrieve the webpage at the target URL, the at least one processor is further configured to execute a search via a search feature at the target URL webpage for a specific content.

13. The system of claim 9, wherein the at least one processor is further configured to:
determine at least one of: (1) that the object list is empty or (2) that the object list is equal to the second object list; and
set the third time to a default time.

14. The system of claim 9, wherein to determine a number of objects in the object list, the at least one processor is further configured to remove an object from the object list, wherein the object is in a prior object list returned from the target web page by a prior retrieval of the webpage.

15. The system of claim 9, wherein the at least one processor is configured to determine the third time to retrieve the webpage at the target URL based on a determined number of non-overlapping objects in the object list compared to the second object list.

16. A non-transitory computer-readable device having instructions stored thereon that, when executed by at least one computing device, cause the at least one computing device to perform operations comprising:
retrieving, via a network, a webpage addressed at the target URL at a first time;
compiling an object list from the webpage;
determining a number of objects in the object list;
retrieving, via the network, the webpage addressed at the target URL at a second time;
compiling a second object list from the webpage;
determining that a number of objects in the second object list is greater than the number of objects in the object list;
based on determining that the number of objects in the second object list is greater than the number of objects in the object list, determining a third next time to retrieve the webpage addressed at the target URL such that a difference between the second time and the third time is less than a difference between the first time and the second time; and
when the determined third time occurs, retrieving, via the network, the webpage addressed at the target URL.

17. The non-transitory computer-readable device of claim 16, wherein the determining the third time comprises:
dividing a scrape frequency parameter by the number of objects in the object list to determine an update frequency, the scrape frequency parameter specifying a time to wait before retrieving the webpage at the target URL; and
multiplying the update frequency by a maximum number parameter specifying a maximum number of objects expected to be found on the webpage, to determine the third time.

18. The non-transitory computer-readable device of claim 16, wherein the operations further comprise:
determining at least one of: (1) that the object list is empty or (2) that the object list is equal to the second object list; and
setting the third time to a default time.

19. The non-transitory computer-readable device of claim 16, wherein determining a number of objects in the object list further comprises removing an object from the object list, wherein the object is in a prior object list returned from the target web page by a prior retrieval of the webpage.

20. The non-transitory computer-readable device of claim 16, wherein the third time to retrieve the webpage at the target URL is further determined based on a determined number of non-overlapping objects in the object list compared to the second object list.
